(19) United States
(12) Patent Application Publication
(10) Pub. No.: US 2018/0100615 A1
(43) Pub. Date: Apr. 12, 2018

(54) TRIPOD HEAD

(71) Applicant: FARO Technologies, Inc., Lake Mary, FL (US)

(72) Inventors: Reinhard Becker, Ludwigsburg (DE); Axel Ruhland, Stuttgart (DE); Andreas Woloschyn, Stuttgart (DE)

(21) Appl. No.: 15/664,268

(22) Filed: Jul. 31, 2017

(30) Foreign Application Priority Data
Oct. 6, 2016 (DE) 10 2016 118 983.9

(51) Int. Cl. F16M 11/12; F16M 11/08; F16M 11/10

(52) U.S. Cl. CPC F16M 11/126; F16M 2200/021; F16M 11/10; F16M 11/08

(57) ABSTRACT

A tripod head for mounting a 3D measurement device on a tripod stand, having a base element, which can be connected to the tripod stand, a cover element, which is configured to cooperate with the 3D measurement device, and a control element by means of which activation of the tripod head changes its state, the states including at least one waiting state, in which the tripod head is ready to operate with the 3D measurement device in the direction of a tripod head axis and the 3D measurement device can be detached from the tripod head, and a locked state, in which the 3D measurement device is fixedly connected to the tripod head, and there is an additional state of the tripod head between the waiting state and the locked state, i.e., a secured state, in which the 3D measurement device sits undetachably on the tripod head.

### CROSS REFERENCE TO RELATED APPLICATIONS

This application claims the benefit of German Patent Application No. 10 2016 118 983.9, filed Oct. 6, 2016, the entire disclosure of which is incorporated herein by reference.

### BACKGROUND

The invention relates to a mounting device for a tripod, and in particular to a mounting head for connecting equipment to a tripod.

A variety of tripod heads, which are used for mounting cameras on tripods, offer various adjustment options for aligning the camera in space and/or means for a quick change of cameras. The latter means are referred to as a “quick-change plate,” for example, and include a separate camera adapter and a second adapter as part of the tripod head. They offer a connection between the camera and the tripod head and at the same time between the camera and the tripod that can be closed and opened easily and quickly. This connection may be form-fitting in one or two coordinate directions, for example, by means of a dovetail profile, and is locked and/or braced in the remaining coordinate directions (in which the tripod head is normally ready to receive the camera adapter). For this purpose, a spring-loaded locking bar or a screw, for example, which creates a high holding force with the least possible rotation, may be used. An adjusting element which can be operated manually in a fast and simple manner acts on the locking bar or the screw for changing the tripod head between the waiting state and the locked state and then back again.

Accordingly, while existing tripod mounting arrangements are suitable for their intended purposes the need for improvements remains, particularly in providing a tripod mounting head as described herein.

### BRIEF DESCRIPTION

In accordance with an embodiment, a tripod head is attached to the tripod, usually to the tripod head which is responsible for the alignment and bearing of the legs, and cooperates with an adapter integrated into the 3D measurement device. The axis of the tripod head is preferably disposed in the direction of gravity so that even heavy 3D measurement devices can be attached easily in the waiting state of the tripod head. In the cylinder coordinate system defined in this way, a form-fitting connection is preferably created in the radial direction, whereas the device is to be locked in the axial direction and in the circumferential direction. The locking leads to creation of the fixed connection between the tripod head and the 3D measurement device, which preferably takes place by means of at least one movable locking mechanism (preferably a plurality of locks) acted upon by a holding force in its direction of action or secured transversely thereto.

In the secured state, which is additionally provided according to an embodiment of the invention, the 3D measurement device sits undetachably on the tripod head. In contrast with the locked state, there may not be a tight connection (nor should there be a strong holding force) but instead a certain relative movement of the tripod head and the 3D measurement device may still be possible—at least within the scope of any play that might still exist. This permits precision positioning, i.e., an alignment of the 3D measuring device that might be necessary before its final locking, without any risk that the 3D measuring device may inadvertently become detached from the tripod head. In the secured state, the tripod head may be secured by the locking bars, which is/are also active in the locked state. However, there may be only a weak holding force or none at all in the secured state, and said play may be present between the locking bars and their counterparts, such as in the 3D measuring device. When changing from the secured state to the locked state, the holding force, which ensures the tight connection between the tripod head and the 3D measuring device, is preferably built up.

A counterpart to the locking bars that may be provided is a receptacle in the 3D measuring device, which opens transversely to the direction of action of the locking bars. Accordingly, the locking bars move into these receptacles on leaving the waiting state by moving transversely to their subsequent direction of action.

A movement is the pivoting of the locking bars, for example, about an axis of rotation of the locking bars which is parallel to the axis of the tripod head. At least one locking bar head of each one of the locking bars provided is then aligned (pivoted) in the circumferential direction in the waiting state and then changes to the radial direction (pivoted out) for the secured state or at the latest for the locked state so that it can be active in the axial direction, i.e., in the direction of the axis of the tripod head. When the locking bar heads are pivoted inward, they may be disposed completely inside the cover element of the tripod head in order to prevent damage. In the case of an axis of rotation of the locking bar aligned otherwise, or in the case of another movement of the locking bars provided, for example, a (radial) displacement, there may also be other alignments with respect to the direction of action of the locking bars.

Said counterpart to the locking bars may be designed directly in the 3D measurement device but may also be arranged in an adapter, for example, a foot plate which is fixedly connected to the 3D measurement device. For example, it may be a window, a flange or an undercut. In the locked state, the locking bars then work together with the respective section of material.

Curved paths, which may be designed in the control element in particular, may be provided for the movement of the locking bars that are provided. The control element to be actuated can move in two directions to achieve a change from one state of the tripod head to another state of same. With three possible states of the tripod head, there are in general two changes, which can optionally be run through differently, depending on the direction (hysteresis), depending on whether the 3D measurement device is to be locked onto the tripod head or released from it. In an embodiment, movement of the control element is rotation.

Pivoting of the locking bars in switching from the waiting state to the secured state and vice versa may be achieved by means of a radial curved path. Such a radial curved path may consist of radial curved path sections which have different radial paths and are aligned side by side in the circumferential direction. The radial curved path is scanned by a radial scanning arm of the locking bar, so that the locking bars can be pivoted out and in by rotation about their locking bar axes of rotation. However, it is also conceivable for an axial curved path to create the desired pivoting of the locking bars by means of oblique contact surfaces. Conversely, a radial curved path can also be scanned by locking bars, which are to be displaced only radially instead of being pivoted.

A relative mobility of the locking bars in the axial direction while building up a holding force in switching to the locked state is compatible with the efficacy of the locking bars provided in the axial direction. This may be achieved by means of an axial curved path that is scanned by an axial scanning arm. Within the context of the axial mobility of the locking bars, one position of the locking bars (due to spring loading, for example) may be provided in the waiting state.

To implement the radial and axial scanning of the curved paths in independent movements as needed, a common cage may be provided for all locking bars. On the one hand the cage scans the axial curved path with said axial scanning arm, such as under spring load (by means of at least one cage spring). In particular the cage has a plurality of axial scanning arms, in one embodiment three, which are disposed with an offset from one another in the peripheral direction and each scans one of several identical sections of the axial curved path. On the other hand, coupling with the locking bars that are provided is possible. This coupling may be accomplished with the insertion of at least one spring acting as a force-limiting device, such as a spring for each locking bar. The spring, which is designed as a compressive spring, may be supported at least temporarily on the locking bar on the one hand, for example, on a securing ring of the locking bar which sits fixedly and on the other hand on the cage, and in one embodiment on a pressure ring acted upon by the cage. The amount of force with which the cage acts upon the locking bars with the intervention of the spring will depend on the course of the axial curved path. With a small portion of the force transferred, the locking bars that are provided are displaced in the axial direction while the other portion is built up as the holding force in the spring.

In an embodiment, the change from the secured state to the locked state of the tripod head and back again takes place by means of manual actuation of the control element, optionally with spring assistance. The switch from the secured state to the waiting state also takes place by means of manual actuation of the control element. The direction of actuation and thus the direction of movement of the control element is intuitive, i.e., it remains the same along a logical sequence of states, for example, from the locked state to the secured state and then to the waiting state, and it reverses when the states are to be run through in the opposite order.

The change from the waiting state to the secured state of the tripod head may take place automatically or by triggering. The control element is prestressed, for example, or may be acted upon by a driver, which is prestressed in the waiting state of the tripod head and is cured—for example, by means of a locking pin. The 3D measurement device releases the driver when placed on the tripod head by direct or indirect actuation of the locking pin, for example. The unlocked driver rotates the control element into the position for the secured state of the tripod head and is prevented from further rotation there. In return from the secured state to the waiting state, the driver is entrained by the control element and is rotated backwards and put under stress at the same time. As soon as the control element has reached the position for the waiting state of the tripod head, the stressed driver is secured again.

The relative alignment of the tripod and the 3D measurement device can usually be chosen freely and can best be placed on an external device, for example, like the 3D measurement device, or can be connected by cable to an external device by a short path. Accordingly, the secured state may be used to find an ideal position of the 3D measurement device, to which end the 3D measurement device can be rotatable relative to the tripod head (about the axis of the tripod head) in the secured state of the tripod head. Such rotatability can also be utilized for testing purposes and calibration purposes, for example, for an inclinometer. In so-called complete stations, there must be rotation about the pivot axis for this functionality.

### BRIEF DESCRIPTION OF THE DRAWINGS

The invention is explained in greater detail below on the basis of an exemplary embodiment, which is illustrated in the drawings with modifications. In the drawings:

FIG. 1 shows a side view of an exemplary 3D measurement device in accordance with an embodiment;

FIG. 2 shows a schematic diagram of the beam path together with a few optical and electronic components in accordance with an embodiment;

FIG. 3 shows a perspective view of the 3D measurement device in accordance with an embodiment;

FIG. 4 shows a bottom view of the 3D measurement device in accordance with an embodiment;

FIG. 5 shows a side view of a tripod head on a tripod in accordance with an embodiment;

FIG. 6 shows a perspective view of a foot plate of the 3D measurement device and of the tripod head in the waiting state in accordance with an embodiment;

FIG. 7 shows a vertical section through the foot plate of the 3D measurement device in accordance with an embodiment;

FIG. 8 shows a vertical section through the tripod head in accordance with an embodiment;

FIG. 9 shows perspective view of the tripod head in the secured state in accordance with an embodiment;

FIG. 10 shows perspective view of the tripod head in the locked state in accordance with an embodiment;

FIG. 11 shows perspective view of a control element of the tripod head as seen obliquely from above in accordance with an embodiment;

FIG. 12 shows perspective view of a control element of the tripod head as seen obliquely from beneath in accordance with an embodiment;

FIG. 13 shows a horizontal section through the tripod head in the waiting state in accordance with an embodiment;

FIG. 14 shows a horizontal section through the tripod head in the secured state beneath the cover element in accordance with an embodiment; and

FIG. 15 shows a perspective view of the tripod head in the secured state without the cover element and the driver in accordance with an embodiment.

### DETAILED DESCRIPTION

Embodiments, of the present invention relates to a 3D (coordinate) measurement device, which deflects a beam of light onto an object O, which may be either a (cooperative) target, for example, a reflector or a non-cooperative target, for example, a diffusely scattering surface of the object O. A distance meter or range finder in the 3D measurement device measures the distance from the object O (i.e., the distance d between the 3D measurement device and the object O), and rotary incremental encoders measure the angle of rotation of two axes in the device. The measured distance and the two angles make it possible for a processor in the device to determine the 3D coordinates of the object O. In one embodiment, a laser scanner 10 is treated as a case of such a 3D measurement device, but the expansion to a laser tracker or to a comprehensive station would be self-evident for those skilled in the art. There is also a possible application for cases, in which the 3D measurement device measures the distance by means of projector-camera arrangements, triangulation, epipolar geometry or strip geometries.

Laser scanners are typically used to scan open or closed spaces, for example, interior surfaces of buildings, industrial installations and tunnels. Laser scanners are used for many purposes including building information modeling (BIM), industrial analyses, accident reconstruction applications, archaeological studies and forensic investigations. A laser scanner may be used to represent, visually detect and measure objects in the surroundings of the laser scanner by detecting data points representing objects within the surroundings. Such data points are obtained by deflecting a beam of light onto the objects and collecting the reflected or scattered light to determine the distance, two angle (i.e., an azimuth angle and a zenith angle), and optionally a gray scale value. These raw scan data are collected, stored and sent to one or more computers to create a three-dimensional image representing the area detected or the object detected. To create the image, at least three values are collected for each data point. These three values may comprise the distance and the two angles or may be converted values, for example, x, y and z coordinates.

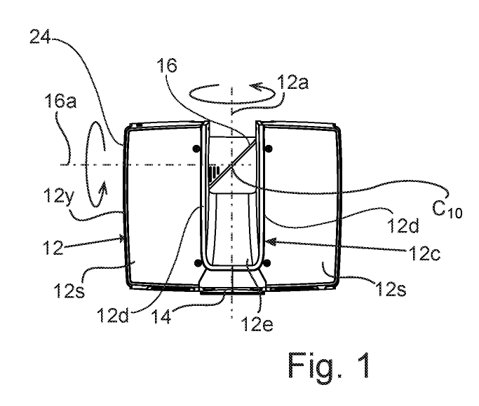

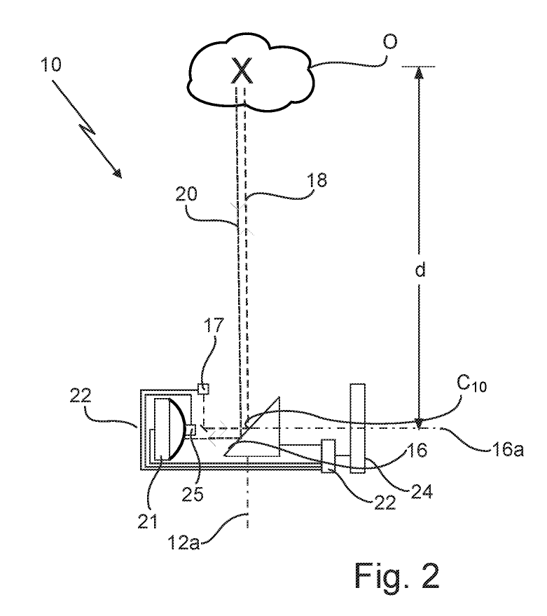

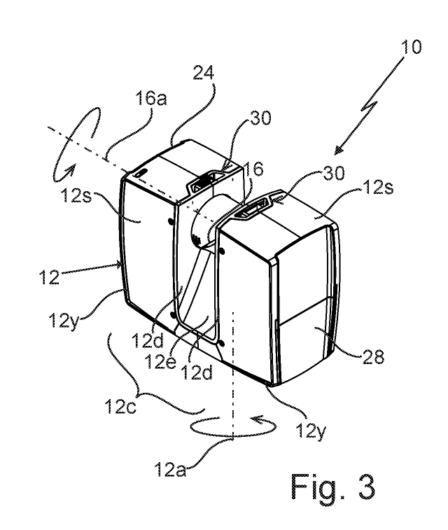

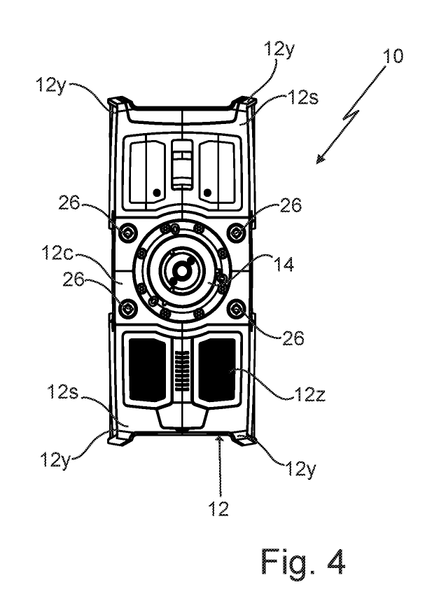

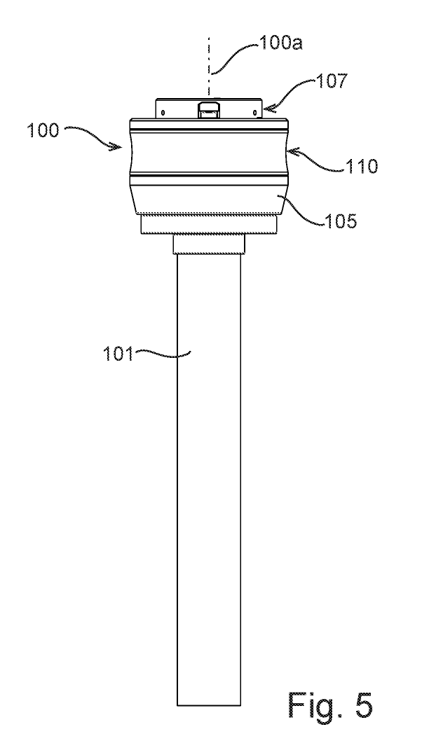

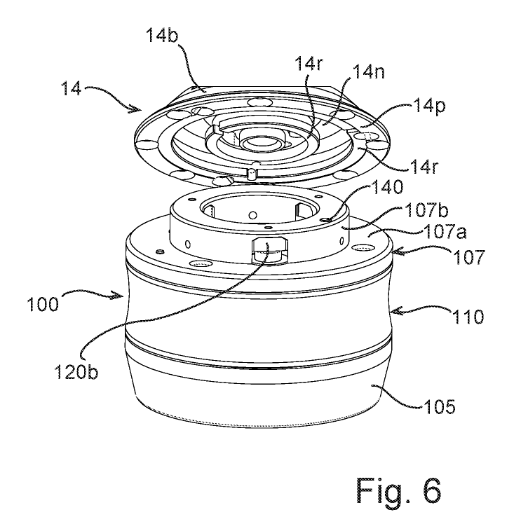

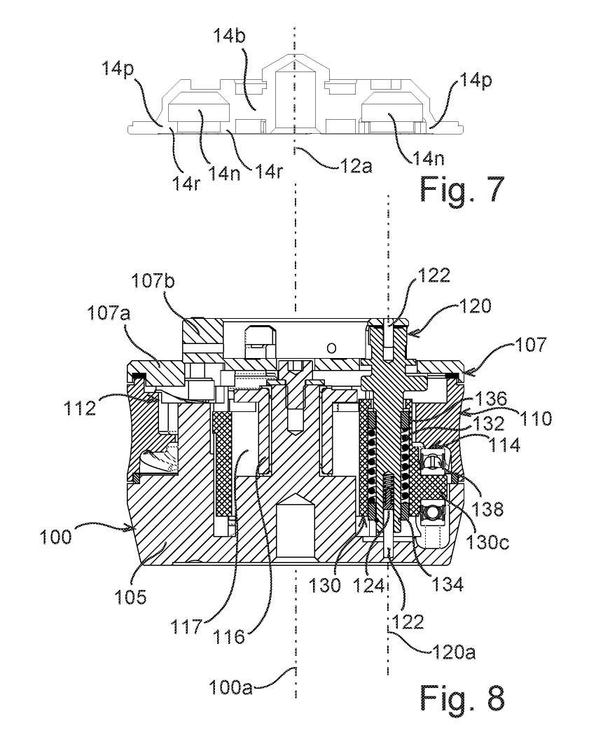

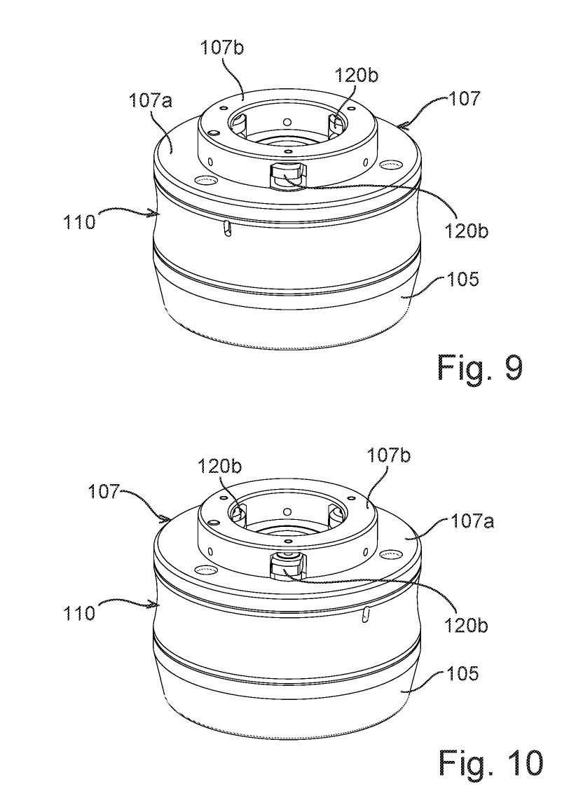

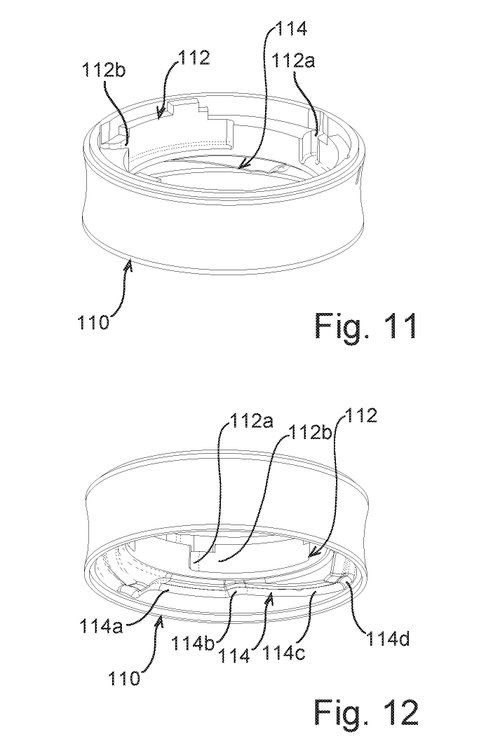

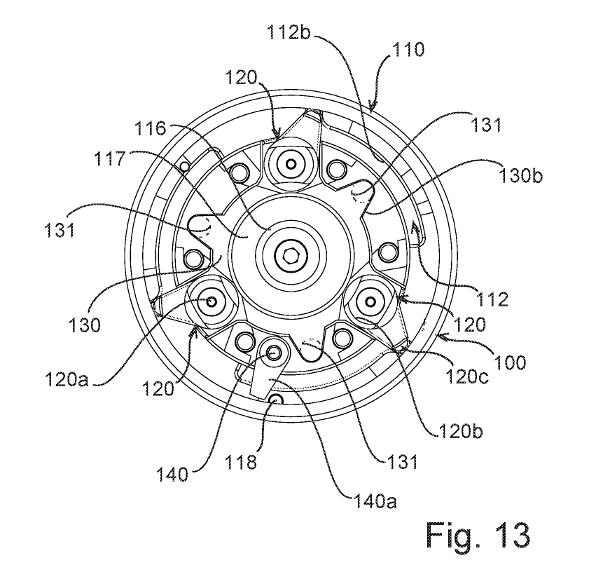

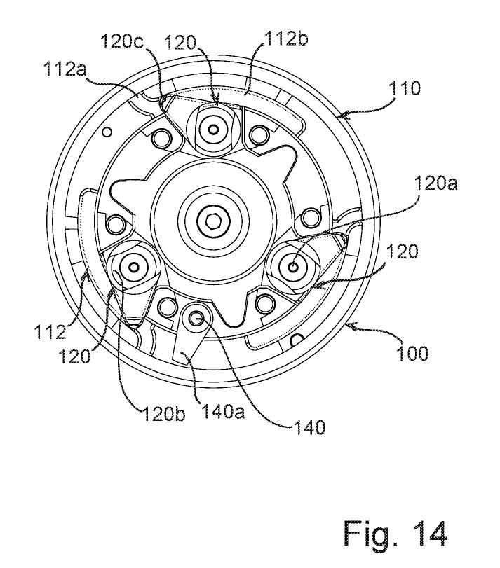

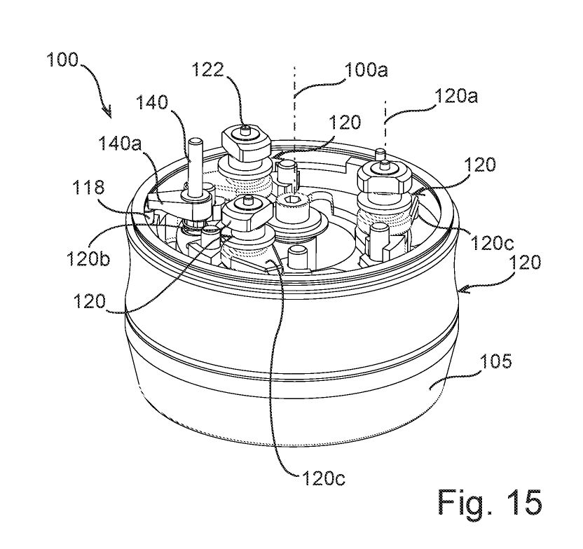

FIG. 1 shows a laser scanner 10 for optical scanning and measurement of the surroundings of the laser scanner 10. The laser scanner 10 has a measurement head 12 and a foot 14. The measurement head 12 is mounted on the foot 14 in such a way that the measurement head 12 can be rotated about a first axis 12a relative to the foot 14, driven by a first rotary drive. Rotation about the first axis 12a may take place about the center of the foot 14. The measurement head has a mirror 16 which can rotate about a second axis 12a, driven by a second rotary drive. Based on a normal upright position (with respect to the direction of gravity) of the laser scanner 10, the first axis 12a may be referred to as a vertical axis or as an azimuthal axis, and the second axis 16a may be referred to as a horizontal axis or a zenith axis. The laser scanner 10 may have a cardan point or center C₁₀, which is the point of intersection of the first axis 12a and the second axis 16a. The first axis 12a defines the terms “top” and “bottom,” although they should be inclined with respect to the direction of gravity.

In the present exemplary embodiment, the measurement head 12 has a support structure 12c, preferably formed from one piece of metal, for example, die-cast aluminum, as the rigid load-bearing structure to which all the other components of the measurement head 12 are attached at least indirectly. The support structure 12c includes two walls 12d which run parallel to one another and to the first axis 12a and a crosspiece 12c, which connects the two walls 12d in a lower area. The crossbar 12e is mounted rotatably on the foot 14 and holds the first rotational drive for rotation of the measurement head 12 about the first axis 12a and the respective rotary angle sensor. In the upper area of the walls 12d, i.e., above the crosspiece 12c, there is an open space, inside of which the mirror 16 supported by one of the two walls 12d is disposed.

The measurement head 12 also has a shell 12s on each of the two sides of the support structure 12c, these shells may be fabricated from a rigid plastic. Each of the two shells 12s is assigned to one of the two walls 12d and is fastened thereon (and therefore on the support structure 12c), for example, with screws. The support structure 12c and the two shells 12s together form a housing for the measurement head 12. The outside edges 12y of the shells 12s are the edges of the shells 12s which are not in contact with the support structure 12c. The outside edges 12y define a volume, within which the measurement head 12 is completely situated. To protect the measurement head 12 from damage, the outside edges 12y may be designed with reinforcement, namely in the present example as protruding thick places in the material (bulges) formed in one piece with the respective shell 12s. Alternatively, the outside edges 12y may be reinforced with a separate bracket.

The shell 12s on the side of the mirror 16 (“mirror-side” shell 12s) accommodates the second rotational drive for the mirror 16 about the second axle 16a and the respective rotary incremental encoder in an upper area of the second rotational drive and in a lower area, it accommodates the cooling 12z for the two rotational drives. The other shell 12s on the side opposite the mirror 16 (“receiver-side” shell 12s) holds some of the optical and electronic components described below together with the power supply, such as the sensitive electronic components, which should be kept away from rotational drives with their electromagnetic interference fields.

The measurement head 12 has a transmitter for electromagnetic radiation, for example, a light emitter 17, which emits an emitted light beam 18. In an embodiment, the emitted light beam 18 is a coherent light, such as a laser beam, for example. The laser beam may have a wavelength in the range of approx. 300 to 1600 nm, for example, 790 nm, 905 nm, 1570 nm, or less than 400 nm. In principle, however, other electromagnetic waves with larger or smaller wavelengths can also be used. The emitted light beam 18 may be amplitude-modulated or intensity-modulated, for example, with a sinusoidal waveform or a rectangular waveform. In another embodiment, the emitted light beam 18 may also be modulated in some other way, for example, by a chirp signal, or coherent methods of reception may also be used. The emitted light beam 18 is sent from the light emitter 17 to the mirror 16, where it is deflected and emitted into the surroundings of the laser scanner 10.

A reflected light beam, hereinafter referred to as a received light beam 20, is reflected by an object O in the environment. The reflected or scattered light is captured by the mirror 16 and deflected to a light receiver 21 having a receiving lens. The directions of the emitted light beam 18 and the received light beam 20 are derived from the angular positions of the measurement head 12 and the mirror 16 about the axes 12a and/or 16a. These angular positions depend in turn on their respective rotational drives. The angle of rotation about the first axis 12a is detected by a first rotary incremental encoder. The angle of rotation about the second axle 16a is detected by a second rotary incremental encoder. The mirror 16 is inclined by 45° with respect to the second axle 16a. It thus deflects all the incident beams by 90°, i.e., both the emitted light beam 18, which is incident along the second axis 16a and also the received light beam 20, which is deflected in parallel to the second axis 16a in the direction of the receiving lens.

A control and evaluation device 22 is in data communication with the light emitter 17 and the light receiver 21 in the measurement head 12. Since the control and evaluation device 22 is a less sensitive component in comparison with the light receiver 21, it may be disposed at different locations in the measurement head 12. In the present exemplary embodiment, it is disposed largely inside the mirror-side shell 12s. Parts of the control and evaluation device 22 may also be disposed outside of the measurement head 12, for example, as a computer connected at the foot 14. The control and evaluation device 22 is designed to determine a corresponding number of distances d between the laser scanner 10 and the measurement points X on the object O. The distance from a certain measurement point X is determined at least in part by the speed of light in air through which the electromagnetic radiation propagates from the device to the measurement point X. In the preferred embodiment, the phase shift in the modulated beam of light 18, 20, which is emitted at measurement point X and received from there is determined and analyzed to obtain a measured distance d.

The speed of light in air depends on the properties of the air such as the temperature of the air, the air pressure, the relative atmospheric humidity and the carbon dioxide concentration. These properties of air influence the refractive index of air. The speed of light in air corresponds to the speed of light in a vacuum divided by the refractive index. A laser scanner of the type described in the present case is based on the transit time of light in air (the transit time required by light to travel from the device to the object and back again to the device). A distance measurement method based on the transit time of light (or the transit time of another type of electromagnetic radiation) depends on the velocity of light in air and can therefore be differentiated easily from distance measurement methods based on triangulation. In methods based on triangulation, light is emitted from a light source in a certain direction and then strikes a camera pixel in a certain direction. Due to the distance between the camera and the projector being known and that a projected angle is balanced with a reception angle, the triangulation method makes it possible to determine the distance from the object on the basis of a known length and to two known angles of a triangle. Therefore, the triangulation method does not depend directly on the velocity of light in air.

In an embodiment, the measurement head 12 has an instruction and display device 24, which is integrated into the laser scanner. For example, the instruction and display device 24 may have a user interface making it possible for the operator to impart measurement instructions to the laser scanner 10, such as to define the parameters or to start the operation of the laser scanner 10, and the instruction and display device 24 can also display measurement results—in addition to the parameters. In the exemplary embodiment, the instruction and display device 24 is disposed on the front side of the mirror-side shell 12s, where its user interface is embodied as a graphical touchscreen.

In addition to the distance d from the center C₁₀ to a measurement point X, the laser scanner 10 may also detect a gray scale value with respect to the received optical power. The gray scale value may be determined by integration of the bandpass-filtered and amplified signal in the light receiver 21 over a measurement period assigned to the measurement point X. Optionally color images can be created by means of a color camera 25. By means of these color images, colors (R, G, B) may also be assigned as additional values to the measurement points X.

In one embodiment, the operating mode of the laser scanner 10 is referred to as the “sphere mode.” This mode allows the detection of the surroundings around the laser scanner 10 by means of a rapid rotation of the mirror 16 about the second axis 16a, while the measurement head 12 rotates slowly about the first axis 12a. In one embodiment, the mirror 16 rotates at a maximum speed of 5820 revolutions per minute. A scan is defined as the totality of measurement points X of such a measurement. For such a scan, the center C₁₀ defines the origin of the local stationary reference system. In this local stationary reference system, the foot 14 is stationary. In the sphere mode, the scan corresponds to a spherical point cloud apart from the area shaded by the transverse 12e.

In another operating mode of the laser scanner 10, the “helix mode,” there is a rotation of the mirror 16 about the second axis 16a while the measurement head 12 remains unmoving in relation to the foot 14. The laser scanner 10 is mounted for example, on a carriage, which moves during the operation of the laser scanner 10. In the helix mode, the scan has a helical shape. The measurement head 12 may have fixation means 26 for securing the measurement head 12 on the carriage, optionally on the foot 14 or on some other support which carries the foot 14 and the measurement head 12 jointly. The bearing between the measurement head 12 and the foot 14 is bridged by means of the fixation means 26 and is thus protected from damage. Fixation of the foot 14 on the carriage by means of the fixation means may not be essential (which would also be advantageous with regard to over-determinations), i.e., the entire laser scanner 10 is affixed to the carriage only by means of the fixation means 26. In one embodiment, the fixation means 26 are embodied as threaded boreholes by means of which the measurement head 12 can be screwed onto the carriage or other carrier.

The light emitter 17, the light receiver 21 and the respective lens are disposed in an upper area of the receiver-side shell 12s of the measurement head 12. A battery pack 28 of the laser scanner 10 which serves as a power supply is disposed in the lower area of this receiver-side shell 12s, such as behind a protective cover which can be separated at least partially from the shell 12s. A pivotable protective flap may be provided as the protective cover. The battery pack 28 may be designed to be replaceable and rechargeable.

In an embodiment, a tripod head 100 is provided for mounting the laser scanner 10 on a stand or tripod 101. The stand 101 may be embodied as a tripod, but it may also be any other stationary or mobile device. The tripod head 100 is fixedly connected to the tripod 101 during use, wherein it may be configured as a separate module or as an integral component of the tripod 101. The tripod head 100 serves as a fast-change closure between the laser scanner 10 and the tripod 101. The tripod head 100 may be in one of three possible states: a) a waiting state in which the tripod head 100 is ready to receive the laser scanner 10 so that the latter can be placed on the tripod head 100 and in which the laser scanner 10 can be separated from the tripod head 100—by lifting it; b) a secured state in which the laser scanner 10 sits on the tripod head 100 so that it cannot be lost, i.e., is secured to prevent separation without any special holding force and therefore is optionally movable to a limited extent relative to the tripod head 100; and c) a locked state in which the laser scanner 10 is fixedly connected to the tripod head 100 (and thus also to the tripod 101) and thus is locked and in the present case is also braced by means of a holding force which maintains the locked state. The tripod head 100 is used in particular when the laser scanner 10 is to be operated in the “sphere mode.”

The tripod head 100 has a base element 105 in its lower area. The base element 105 defines a cylinder coordinate system based on its external shape, such that the tripod head axis 100a (which defines the axial direction) coincides with the first axis 12a of the laser scanner 10 when the laser scanner 10 is mounted in place. At the same time the arrangement used during use in the gravitation field defines the specifications “above” and “below.” The tripod head axis 100a specifies the direction in which the tripod head 100 can accommodate the laser scanner 100 and can be separated from it again. The tripod head 100 may be to be connected to the tripod 101 in a known manner. To do so, the base element 105 in the present case has a blind hole running in the axial direction on its underside, said blind hole having an inside thread into which a screw of the tripod stand 101 can be screwed.

The upper area of the tripod head 100, which is at the top in the axial direction, is formed by a cover element 107. The cover element 107 is fixedly connected to the base element 105, such as by screw connection. With regard to its shape, the cover element 107 consists of a flat plate 107a, with a ring 107b protruding away from its top side, i.e., an annular section of material protruding upward in the axial direction. The movable components of the tripod head 100 are mounted between the base element 105 and the cover element 107. The top side of the plate 107a situated on the outside of the ring 107b radially is configured as a standing surface for the foot 14 of the laser scanner 10. In other embodiments, the top side of the plate 107a situated on the inside of the ring radially and/or the top side of the ring 107b may be configured as standing surfaces for the foot 14 of the laser scanner 10.

A control element is configured in a ring shape and can be rotated manually about the tripod head axis 100a of the tripod head 100—at least over a predetermined angular range. The rotatable bearing of the control element may be accomplished on its ends facing in the axial direction. In one embodiment, the control element 110 is supported axially with friction bearings at the top of the plate 107 and is supported radially with friction bearings on the base element 105 at the bottom. On its outside radially, the control element 110 is provided with an ergonomically shaped area suitable for manual operation without any additional tools, namely with a peripheral gripping channel in the present case. Instead of the gripping channel or the other ergonomically shaped area, some other means for a good slip-free contact between the fingers of the operator and the control element 110 may be provided.

A first curved path, referred to below as radial curved path 112, and a second curved path, referred to below as axial curved path 114 are formed on the control element 110 on the inside. With regard to their course, the radial curved path 112 has a first radial curved path segment 112a running from radially outside to radially inside and following that, a much longer second radial curved path segment 112b running at a constant radius. After a section of material protruding radially inward, the course of the radial curved path 112 is repeated after every 120°, so that the same course appears three times. The axial curved path 114 has a first axial curved path segment 114a which runs axially at a constant height and to which is connected a step-shaped second axial curved path segment 114b which at the same time forms the highest point in the axial curved path 114 (at the top in the axial direction). Connected thereto is a ramp-shaped third axial curved path segment 114c which declines in the axial direction and ends in a trap as the fourth axial curved path segment 114d. The fourth axial curved path segment 114d at the same time forms the lowest point (at the top in the axial direction) of the axial curved path 114. A step at the height of the first axial curved path segment 114a is situated behind the fourth axial curved path segment 114d. This course is repeated every 120°. The control element 110 controls the transitions between the waiting state, the secured state and the locked state of the tripod head 100 by means of the two curved paths 112, 114.

In modified embodiments, the two curved paths 112, 114 have different segments and courses in detail.

A driver 116 is mounted on a central mandrel of the base element 105 by means of a sleeve-shaped segment which is rotatable about the tripod head axis 100a. Two cantilevered arms of the driver 116 protrude radially outward from the sleeve-shaped segment. A driver spring, which in one embodiment is configured as a spring leg, puts the driver 116 under tension with respect to the base element 105 in the circumferential direction. The driver spring is situated inside an installation space 117 disposed around the driver 116 in the base element 105. A locking pin 118 is mounted in the control element 110, so that it is axially displaceable. The locking pin 118 cooperates with the plate 107a, more specifically a step thereof, thereby securing the prestressed driver 116 by contact with the step. When the driver 116, which is under prestress by means of the driver spring, is released by the locking pin 118, it acts on the control element 110 to bring it from the waiting state in the direction of the secured state.

The three locking bars 120 are disposed so that they are offset in parallel in the radial direction relative to the tripod head axis 100a, while being uniformly distributed in the circumferential direction (i.e., every 120°) and are enclosed radially by the handle element 110. Each of the locking bars 120 has an elongated base body and is mounted to be rotatable about a locking bar axis of rotation 120a which is parallel to the tripod head axis 100a, namely being mounted at one end in the base element 105 and at the other end in the ring 107b of the cover element 107. In addition, each locking bar 120 is displaceable to a limited extent along its locking bar axis of rotation 120a. To this end, bearing pins 122 are provided on both axial ends of the locking bar 120, these bearing pins sitting fixedly in the base element 105 and/or in the ring 107b, on the one hand, and, on the other hand, and engaging in boreholes of the blind hole type in the locking bar 120, so they are flush with the locking bar axis of rotation 120a at the other end. A bearing spring 124 is also disposed between the lower bearing pin 122 and the locking bar 120, such as between the upper end of the lower bearing pin 122 and the base of the lower borehole of the blind hole type in the locking bar 120. The weak bearing spring 124 lifts the locking bar 120 upward against its weight.

Each locking bar 120 has two opposing locking bar heads 120b, which protrude radially from the elongated base body (with respect to the locking bar axis of rotation 120a). The two locking bar heads 120b, which together with the upper end of the locking bar 120 form a hammer shape, such as being integrally molded, i.e., designed in one piece with the locking bar 120. By rotating the locking bar 120 about the locking bar axis of rotation 120a, each locking bar head 120b that is provided pivots between a state, in which it is pivoted outward and protrudes radially (with respect to the tripod head axis 100a) out of a window in the ring 107b, and an inwardly pivoted state, in which it is disposed inside the ring 107b in a receptacle connected to the window. In one embodiment, only one locking bar head 120b is provided per locking bar 120.

Each locking bar 120 has a first scanning arm, hereinafter referred to as a radial scanning arm 120c which protrudes radially (with respect to the locking bar axis of rotation 120a) and is offset axially in relation to the locking heads 120b. The free end of the radial scanning arm 120c serves to query the radial curved path 112 of the control element 110. To increase the contact surface area, the free end of the radial scanning arm 120c, which is configured like a peg, is bent in the axial direction. To reduce the friction, a sliding bearing (for example, a plastic ring) or a roller bearing may be provided between the radial scanning arm 120c and the radial curved path 112, surrounding the bent free end of the radial scanning arm 120c and being in contact with the radial curved path 112 on its outside radially.

The three locking bars 120 are disposed with their respective elongated base bodies inside a cage 130—as seen axially between the respective radial scanning arm 120c and the respective lower end of the locking bar 120. The cage 130 has on the whole three cantilevered arms 130b, which are offset in the peripheral direction relative to the locking bars 120. Between each of these cantilevered arms 130b and the base 105, a cage spring 131 is disposed, stressing the cage 130 axially upward. Each locking bar 120 is surrounded by the respective compression spring 132 which is in turn surrounded by the cage 130. In comparison with the bearing springs 124 and cage springs 131, the three compression springs 132 are designed to be strong. On their lower end, each compression spring 132 is supported on a securing ring 134, which sits securely on the locking bar 120, for example, by means of a spring ring. At its upper end, the prestressed compression spring 132 presses against a pressure ring 136, which is displaceable on the elongated base body of the locking bar 120 and is in contact with a step of the locking bar 120 disposed above the pressure ring 136 in the starting position. A flange facing radially inward is formed on the cage 130, opposite said step and offset radially outward. In said starting position, the flange on the cage 130 is disposed above the pressure ring 136 and is a distance apart from it with free travel. The cage 130 is supported in a twist-proof manner in the base element 105 so that the locking bars 120 are not exposed to any transverse forces.

A second scanning arm, hereinafter referred to as an axial scanning arm 130c, protrudes radially outward from the cage 130. The free end of the axial scanning arm 130c serves to scan the axial curved path 114 of the control element 110. To reduce friction, a friction-bearing or a roller bearing 138 (wheel-shaped type) may be provided between the axial scanning arm 130c and the axial curved path 114. This roller bearing surrounds the axial scanning arm 130, which is designed as a bearing journal and is in contact with the axial curved path 114 on its outside radially. The cage springs 131 hold the axial scanning arm 130c in contact with axial curved path 114, i.e., the cage 130 scans the axial curved path 114 in a spring-loaded process.

A deployment pin 140 is mounted so that it is axially displaceable in the ring 107b of the cover element 107. In the waiting state of the tripod head 100, the deploying pin 140 protrudes beyond the top side of the ring 107b, i.e., it protrudes axially upward. In the lower area of the deployment pin 140, a deployment arm 140a is attached, by means of which the deployment pin 140 can act upon the locking pin 118 if the latter is in contact with the step of the plate 107a (and thereby secures the prestressed driver 116).

The foot 14 of the laser scanner is configured to cooperate with the tripod head 100.

Therefore, the foot 14 has a foot plate 14b. An annular groove 14n, which serves to receive the ring 107b of the cover element 107, and a material section 14p, which borders the annular groove 14n radially on the outside and whose bottom side serves to be in contact with the plate 107a, are provided in this foot plate 14 on the bottom side in the present case. Furthermore, a flange 14r is formed on this material section 14p—and in the present case also on the material section situated on the other side of the annular groove 14n and bordering the annular groove 14n on the inside radially, and said flange covers the annular groove 14n somewhat so that an undercut is provided in the annular groove 14n at least on the outside radially. Both the base of the annular groove 14n and the bottom side of the material section 14p, which is on the outside radially are provided as running surfaces for a relative rotation of the foot 14 on the tripod head 100.

Without an attached laser scanner 10, the tripod head 100 is in a waiting state. The deployment pin 140 protrudes upward. With each locking bar 120, the locking bar heads 120b that are provided are pivoted into the ring 107b, and the radial scanning arm 120c is in the radial curved path 112 on the end of the respective first radial curved path segment 112a which is on the outside radially. Each locking bar 120 is in its top position along its locking bar axis of rotation 120a, held by the prestress. In the case of the axial curved path 114, the cage 130 is at a distance from the pressure ring 136 and the axial scanning arm 130c is situated on the outer end of the first axial curved path segment 114a.

If the laser scanner 10 is placed on the tripod head 100, the annular groove 14n engages in the foot plate 14b by means of the ring 107b. When the laser scanner 10 is set in place, the deployment pin 140 is forced downward from the foot plate 14b of the foot 14 or, more specifically, from the base of the annular groove 14n. In doing so, the deployment pin 140 in turn forces the locking pin 118 downward by means of the deployment arm 140a until the locking pin is released from the step on the plate 107a. In this way the driver springs can rotate the driver 116 by a predetermined angle up to the stop, so that the control element 110 is rotated by the same angle (counterclockwise as seen from above). With the rotation of the control element 110, the radial curved path 112 or, in one embodiment, the first radial curved path segment 112a and then the beginning of the second radial curved path segment 112b is passed by the radial scanning arm 120c. At the same time, the axial curved path 114 with its respective first axial curved path segment 114a is passed by the respective axial scanning arm 130c. Because of the course of the radial curved path 112, each radial scanning arm 120c and therefore each locking bar 120 is pivoted. The locking bar heads 120b pivot out of the ring 107b, so that in the present case three locking bar heads 120b protrude radially outward, and three locking bar heads 120b protrude inward radially. The locking bar heads 120 that have been pivoted outward engage with the respective assigned flange 14r, but at a distance from it. The respective axial scanning arms 130c have entered the respective second axial curved path segments 114b. The tripod head 100 is now in the secured state. The laser scanner 10, more specifically its foot 14, can be rotated relative to the tripod head 100 but cannot be lifted.

Since there is practically no relative movement of the radial scanning arm 120c and the first radial curved path segment 112a in the peripheral direction during the pivoting movement of the locking bar heads 120b (in contrast with the relative movement of the axial scanning arm 130c and the first axial curved path segment 114a in the circumferential direction), the radial curved path 112 is shorter on the whole in the circumferential direction than the axial curved path 114.

Starting from the secured state of the tripod head 100, the control element 110 can be rotated further (counterclockwise, as seen from above). In doing so, the axial path curve 114 moves in relation to the respective axial scanning arm 130c of the cage 130 with its respective ramp-shaped third axial curved path segment 114c—in all three angular ranges in the circumferential direction. In other words, the axial scanning arm 130c scans the axial curved path 114 by means of its roller bearing 138 and under load by means of the cage springs 131. Since the third axial curved path segment 114c runs axially downward, the respective cage 130 is forced axially downward. After it has come into contact with the pressure ring 136, it additionally compresses the compression spring 132 and pushes the respective locking bar 120 axially downward, so that the locking bar heads 120b that are provided come into contact with the respective flange 14r. The compression springs equalize the loads among one another, so that all the locking bars 120 are subject to uniform loads. At the same time the compression springs 132 allow the cage 130 to be bridged depending on the segment of the axial curved path 114. The movement of the radial scanning arms 120c along the second radial curved path segments 120b takes place without any change in force. With the compression of the compression spring 132, a (additional) holding force is built up. This holding force presses the locking bar head 120b against the flange 14r and reaches its maximum when at least one of the axial scanning arms 130c has reached the respective fourth axial curved path segment 114d, i.e., the trap, with its roller bearing 138. The tripod head 100 is then disposed in the locked state.

Starting from the locked state of the tripod head 100, the control element 110 can be rotated in the opposite direction (clockwise as seen from above). On leaving the respective fourth axial curved path segment 114d, the axial scanning arms 130c each reach the third axial curved path segment 114c so that the compression springs 132 that are provided (and the cage springs 131) can relax and thereby push the respective locking bars 120 axially upward. The control element 110 is rotated until the axial scanning arms 130c have reached the respective second axial path segment 114b, i.e., the cages 130 are raised up from the respective pressure rings 136 and thus have released the respective locking bars 120. The tripod head 100 has again reached the secured state.

The control element 110 can then be rotated further in the same direction (clockwise as seen from above), wherein the axial scanning arms 130c move along the first axial curved path segments 114a, supported by the relaxing bearing springs 124. The radial scanning arms 120c go from the respective second radial curve path segments 120b into the first radial curved path segment 120a so that the locking bars 120 are pivoted about their respective locking bar axis 120a. The locking bar heads 120b are pivoted into the bulge 107b. The tripod head 100 is now in the waiting state and the laser scanner 10 can be raised.

The term “about” is intended to include the degree of error associated with measurement of the particular quantity based upon the equipment available at the time of filing the application.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A tripod head for mounting a 3D measurement device on a tripod, having a base element which can be connected to the tripod, the tripod head comprising:
a cover element configured to cooperate with the 3D measurement device and
a control element having a means of the actuation of which the tripod head changes its state between at least one waiting state in which the tripod head is ready to receive the 3D measurement device in the direction of its tripod head axis an in which the 3D measurement device can be separated from the tripod head again, and a locked state, in which the 3D measurement device is fixedly connected to the tripod head
wherein a secured state is provided as an additional state of the tripod head, the secured state being between the waiting state and the locked state, such that in the secured state, the 3D measurement device sits undetachably on the tripod head.

2. The tripod head according to claim 1, further comprising at least one locking bar, which is movable by means of the control element and secures the 3D measurement device in the secured state by cooperating with and locking it in the locked state.

3. The tripod head according to claim 2, wherein each locking bar that is provided can be rotated about a locking bar axis of rotation that is parallel to the tripod head axis, and has at least one locking bar head that protrudes with respect to the locking bar axis of rotation, said locking bar head being pivotable into the cover element in the waiting state of the tripod head and being pivotable out of the cover element in the secured state and in the locked state.

4. The tripod head according to claim 3, wherein each locking bar that is provided scans a radial curved path on the control element by means of a radial scanning arm, and is pivoted in and out on activation of the control element according to the course of the radial curved path segments by rotation about the locking bar axis of rotation.

5. The tripod head according to claim 3 wherein each locking bar that is provided is mounted to be displaceable along its locking bar axis of rotation wherein the respective bearing spring prestresses the locking bar at least in the waiting state of the tripod head.

6. The tripod head according to claim 2, wherein the locking bars that are provided are disposed by sections in a cage, wherein a compression spring by means of which the locking bar can be acted upon by the cage is active at least temporarily between each locking bar that is provided and the cage.

7. The tripod head according to claim 6, wherein each cage that is provided scans an axial curved path on the control element by means of an axial scanning arm, in particular being loaded by means of a cage spring and, on activation of the control element in accordance with the course of the axial curved path segments acts upon the respective locking bar by means of the compression at least temporarily in order to displace it.

8. The tripod head according to claim 1, further comprising a driver which is prestressed and secured in the waiting state of the tripod head and which is released by the 3D measurement device when placed on the tripod head so that the driver rotates the control element into the position for the secured state of the tripod head.

9. The tripod head according to claim 1, wherein the 3D measurement device can be rotated relative to the tripod head about the tripod head axis in the secured state and/or when changing to the secured state of the tripod head.

10. The tripod head according to claim 1, wherein the tripod head is operable to builds up a holding force for the secure connection between the tripod head and the 3D measurement device in changing from a secured state to the locked state.

11. A system comprising:
A 3D measurement device;
a tripod;
a base element coupled to the tripod;
a tripod head having a cover element and a control element, the control element operable to change a tripod head between a waiting state, a locked state and a secured state in respond to rotation of the control element relative to the 3D measurement device, wherein in the waiting state the tripod head is operable to receive the 3D measurement device in a direction of a tripod head axis and in which the 3D measurement device can be removed from the tripod head, wherein in the locked state the tripod head is operable to couple the 3D measurement device to the tripod head, and wherein in the secured state is configured to be between the waiting state and the locked state such that the 3D measurement device sits undetachably on the tripod head.

12. The system of claim 11, wherein
a foot member coupled to the 3D measurement device, the foot member having an annular groove; and
the cover element includes a ring shaped projection sized to be received in the annular groove,

13. The system of claim 12, wherein:
the tripod head further includes at least one locking bar having a head portion extending through the ring shaped projections;
the head portion being movable between the waiting state, the locked state and the secured state;
the head portion being at least partially disposed in the annular groove in the secured state and the locked state.

14. The system of claim 13, wherein the head portion is in a retracted position within the ring shaped projection in the waiting state.

15. The system of claim 13, wherein the at least one locking bar is rotatable about an axis parallel to a tripod head axis.

16. The system of claim 13, wherein the annular groove further includes a flange, the head portion cooperating with the flange in the secured state and the locked state.
